(19) United States
(12) Patent Application Publication
(10) Pub. No.: US 2016/0341532 A1
(43) Pub. Date: Nov. 24, 2016

(54) FUZE SETTING APPARATUS

(71) Applicant: BAE SYSTEMS PLC, London (GB)

(72) Inventors: RHYS HUW OWEN, Usk Monmouthshire (GB); STEPHEN JOHN ATKINSON, Usk Monmouthshire (GB)

(73) Assignee: BAE SYSTEMS PLC, London (GB)

(21) Appl. No.: 15/112,827

(22) PCT Filed: Jan. 20, 2015
(86) PCT No.: PCT/GB2015/050115

§ 371 Date: Jul. 20, 2016

(30) Foreign Application Priority Data
Jan. 20, 2014 (GB) 1400887.4

(51) Int. Cl. F42C 17/04; H04B 5/00

(52) U.S. Cl. CPC F42C 17/04; H04B 5/0031

(57) ABSTRACT

An electronic fuze system comprising a fuze setter (110) and electronic fuze (112), wherein signals are transmitted between the fuze setter (110) and the electronic fuze (112) by a radio-frequency electromagnetic coupling link which facilitates data transmission via a wireless communication standard between a first induction-loop antenna (116) and a second induction-loop antenna (118) driven by the electronic fuze.

This invention relates to an electronic fuze system and, in particular, but not exclusively, to an electronic fuze system for use in munitions systems.

In military munitions, a fuze is the part of the device that initiates a function. A fuze is thus a sophisticated ignition device incorporating mechanical and/or electronic components, e.g. a proximity fuze, magnetic/acoustic fuze, spring-loaded grenade fuze, etc.

Fuzes are set, where required, using either a manual action, for example, using a hand-dial or screwdriver, or electronic communication using, for example, induction coil technologies.

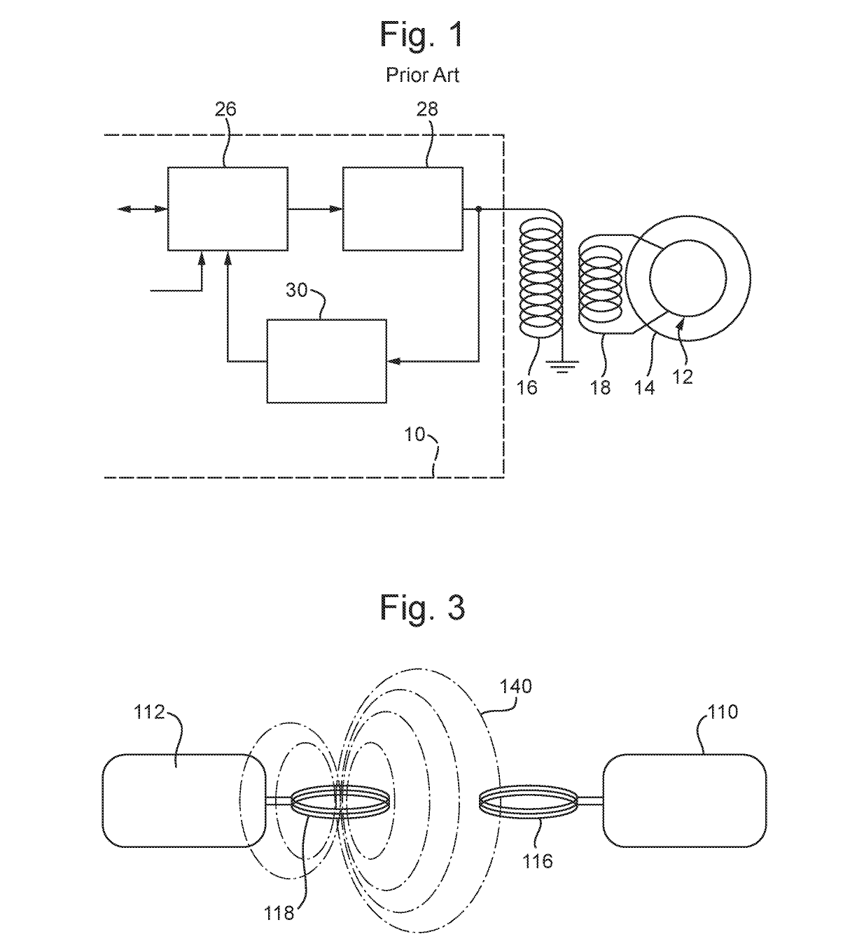

Referring, for example, to FIG. 1 of the drawings, comprises a fuze setter 10 and an electronic fuze 12 incorporated in a munition system 14. Communication between the fuze setter 10 and the electronic fuze 12 is provided by a magnetic coupling link between an induction coil 16 driven by the fuze setter and an induction coil 18 driven by the electronic fuze. The fuze setter 10 incorporates a controller 26 linked to other control modules (not shown), such as a range finder, projectile sensors, and a processor for providing data such as fuze setting data, time of flight data, target information, navigation assistance and environmental parameters. In response to predetermined data from the other control modules, the controller 26 causes a transmitter 28, which may be in the form of an oscillator or the like, to generate a high frequency signal, which drives the induction coil 16 and is communicated to the electronic fuze via the induction coil 18 whilst the two coils are linked in magnetically coupled relation, causing the electronic fuze to trigger the ignition of a detonator (not shown) within the munition system. It will be appreciated that the fuze setter 10 may also include a receiver (not shown) which enables the electronic fuze to communicate with the controller 26 while the induction coils 16, 18 are magnetically linked.

Electronic fuzing using induction coil technology requires a large coil in both the electronic fuze and in the fuze setter, and also requires a large power source in the fuze setter, which can be heavy and pose an unnecessary burden to the user, particularly in relation to dismounted (man-deployable) munitions systems.

It is therefore an object of the present invention to provide an electronic fuze which addresses these issues and overcomes, or at least mitigates, some of the problems outlined above.

Thus, in accordance with the present invention, there is provided an electronic fuze setter and electronic fuze arrangement, said fuze setter including a first antenna and said electronic fuze comprising a second antenna, wherein the fuze setter is configured to transmit a signal via said first antenna to said second antenna by means of a wireless communication standard when said first and second antennae are brought into proximity.

The wireless communication standard may be RFID, wi-fi or li-fi, but is most preferably Near Field Communication. Thus, preferably, the signal is an alternating data signal, wherein the frequency of said signal is substantially 13.56 MHz. According to the Near Field Communications standard, the arrangement is preferably configured to transmit said signal from said first antenna to said second antenna when said electronic fuze setter and electronic fuze are brought into proximity, and most preferably when said electronic fuze setter and electronic fuze are within a range of up to substantially 1.5 metres of each other.

The signal is preferably a data signal, and may comprise one or more of fuze setting data, time of flight data, target information data, navigation assistance data, environmental parameter data, output parameters and product/munition data.

The first and second antennae may be induction-loop antennae, wherein the respective planes of the coils of said first and second antennae are beneficially substantially parallel.

The present invention extends to an electronic fuze setter for use in the arrangement described above, comprising an antenna, a power supply for supplying power to said antenna, a transmitter for applying modulated data signals to said antenna, the antenna being configured to transmit said data signals by means of Near Field Communication to a compatible electronic device.

The electronic fuze setter beneficially comprises a Near Field Communication module for receiving and processing data signals received by said antenna from a compatible electronic device by means of Near Field Communication.

The present invention further extends to an electronic fuze for use in the arrangement of any of claims 1 to 8, comprising an antenna and a Near Field Communication processing module for receiving and processing data signals received by said antenna from a compatible electronic device by means of Near Field Communication.

The electronic fuze beneficially further comprises a power supply for supplying power to said antenna, and a transmitter for applying modulated signals to said antenna, the antenna being configured to transmit said data signals to a compatible electronic device by means of Near Field Communication.

The present invention extends still further to a munition system including an electronic fuze as described above, and to a portable or wearable control device, for example a smart card or glove, including the electronic fuze setter described above.

Also in accordance with the present invention, there is provided a method of operating an electronic fuze having a first antenna, the method comprising bringing an electronic fuze setter having a second antenna and said electronic fuze into proximity so as to induce an electromagnetic field between said first and second antennae, and thereby transmitting a control signal from said second antenna to said first antenna by means of a wireless communication standard.

The wireless communication standard preferably comprises Near Field Communication.

The use of Near Field communication technology has numerous benefits, such as the significant reduction of the overall size of the arrangement, thereby removing the burden of carrying additional equipment into dismounted scenarios. Furthermore, the high data rate offered by Near Field Communication could improve the maximum rates of fire of weapon systems by enabling munitions to be set in less than 4 seconds to sustain higher rates of fire.

In a further arrangement there may be provided a further electronic fuze setter and optionally a further electronic fuze arrangement located on the munition, wherein said further fuze setter is brought into operative contact with said electronic fuze arrangement or further electronic fuze arrangement to disengage at least one safety and arming unit activation located on said munition; prior to setting the electronic fuze with the electronic fuze setter. The use of at least two separate electronic fuze setters provides enhanced safety and arming to munitions during storage and transport.

An embodiment of the invention will now be described by way of example only and with reference to the accompanying drawings, in which:

FIG. 1, which has already been referenced herein, is a schematic block diagram of a fuze setter and electronic fuze arrangement according to the prior art;

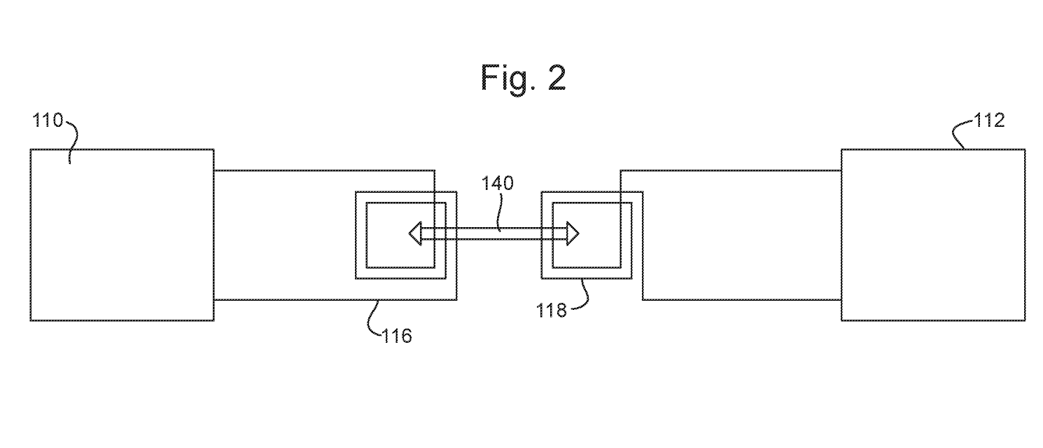

FIG. 2 is a schematic block diagram of a fuze setter and electronic fuze arrangement according to an exemplary embodiment of the present invention; and

FIG. 3 is a schematic diagram illustrating the operation of NFC in the context of a fuze setter and electronic fuze arrangement according to an exemplary embodiment of the present invention.

By way of background, Near Field Communication (NFC) is based on short-range wireless connectivity technology, and comprises a set of standards for enabling secure, two-way radio communication between two electronic devices when they are brought into close proximity. NFC uses electromagnetic radio fields to communicate. This is in contrast to Bluetooth or Wi-Fi which use radio transmissions, although NFC is compatible with both technologies. NFC operates at 13.56 MHz and has a read and write mode, and can transfer data at a rate up to 424 Kbits/second and is inherently secure as the distance requirement is so close.

NFC builds on Radio Frequency Identification (RFID) technology, in the sense that it is implemented by wireless non-contact use of radio-frequency electromagnetic fields to transfer data between two electronic devices, each having a respective antenna associated therewith.

Referring to FIG. 2 of the drawings, an electronic fuze system according to an exemplary embodiment of the present invention comprises a fuze setter 110 and an electronic fuze 112 incorporated in a munition system 114. Communication between the fuze setter 110 and the electronic fuze 112 is provided by a radio-frequency electromagnetic coupling link between a first induction-loop antenna 116 driven by the fuze setter and a second induction-loop antenna 118 driven by the electronic fuze. The fuze setter 110 incorporates a controller 126 linked to other control modules (not shown), such as a range finder, projectile sensors, and a processor for providing data such as fuze setting data, time of flight data, target information, navigation assistance and environmental parameters. The controller may include RAM and ROM functionality such that the fuze setting parameters therein can be readily programmed and selectively re-programmed, as required.

In response to predetermined data from the other control modules, the controller 126 causes a transmitter 128, which may be in the form of an oscillator or the like, to generate a high frequency signal, which causes an alternating current (modulated in accordance with the data signals to be transmitted) to pass through the induction-loop antenna 116. Referring additionally to FIG. 3 of the drawings, when the two induction-loop antennas 116, 118 are brought into proximity, an electromagnetic field 140 is induced between them, which causes the same modulated alternating voltage to appear across the second induction-loop antenna 118, thereby effectively transmitting the required data signals thereto.

If the electronic fuze is a ‘passive’ NFC receiver, i.e. it does not have it's own power supply, it uses the alternating voltage appearing across it, due to the above-mentioned electromagnetic induction, as its power supply to set up a corresponding alternating current therein. If, as is more likely, the electronic fuze arrangement is an ‘active’ device, it has its own power supply which causes an alternating current to pass through its induction-loop antenna 118 when it is connected thereto, which alternating current is modulated by the voltage set up across the antenna as a result of the above-mentioned electromagnetic induction.

In either case, the modulated alternating signal in the antenna 118 is then read and processed, and the required action taken by the internal control modules of the electronic fuze 112. It will be appreciated that the fuze setter 110 may also include a receiver (not shown) which enables the electronic fuze to communicate with the controller 126 while the antennas 116, 118 are electromagnetically coupled, in the same manner as described above.

The transmission range of the communication devices is directly linked to the transmission frequency (the distance must be considerably smaller than the wavelength), with an upper limit of around 1.5 metres. The antennae sizes determine the efficiency of the power transmission between the devices—so, the larger the antennae, the longer the range. Also, to maximise the concatenated flux (amount of magnetic field “trapped” by the ‘receiving’ antenna), the planes where the device antenna coils lay are preferably substantially parallel, in use.

In conventional fuze setting arrangements, additional modules within the fuze setter might include a range finder, such as a laser range finder, which is sighted on a target. The target range information developed by the range finder is then sent to the control computer, which solves the projectile ballistics equation to produce a time-of-flight solution for the sighted target. This solution, in the form of projectile time-of flight data, is communicated to the controller which then triggers the transmitter, as described above with reference to FIG. 1 of the drawings. Thus, conventional current induction technology is considered sufficient for standard fuze functions, which require transmission of minimal data relating to fuze function and time of flight. However, the improved data rate offered by Near Field Communication technology, and the ever increasing requirement for data on-board, means that the present invention improves the system integration and performance of ‘data heavy’ fuzes and munitions, which may require transmission of fuze setting data and time of flight data and, additionally, one or more of target information data (co-ordinates or discriminators), navigation assistance data (launch position, satellite ephemeris, etc), environmental parameter data (e.g. meteorological conditions), output parameters, such as, for example to select the terminal effect output to reduce collateral damage, and product/munition data (e.g. age, temperature, exposures, etc).

It will be appreciated therefore that the use of Near Field Communication in the present invention can offer a low-cost, adaptable communication sub-system for an electronic fuze and fuze setter arrangement, with the benefits of high speed, reliable communication, much smaller form factor than that offered by conventional induction coil communication technologies in terms of size, weight and power supply requirements. Furthermore, conventional induction coil technology limits the range to which a fuze or munition can be set, whereas with the present invention, multiple fuzes can be set, at, for example, 1 m intervals, thereby enabling a more convenient location setting to be used. Fuzes and munitions could also be settable within their packaging.

It will be further appreciated a person skilled in the art that modifications and variations can be made to the described embodiment, without departing from the scope of the invention as claimed.

1. An electronic fuze system, comprising:
a fuze setter including a first antenna; and
an electronic fuze including a second antenna;
wherein the fuze setter is configured to transmit a signal via said first antenna to said second antenna by means of a wireless communication standard when said first and second antennae are brought into proximity.

2. A system according to claim 1, wherein said fuze setter is configured to transmit a signal via said first antenna to said second antenna by means of Near Field Communication.

3. A system according to claim 1, wherein said signal is an alternating signal.

4. A system according to claim 1 wherein the system has a transmission range that is directly linked to transmission frequency of the signal, such that the distance between the fuze setter and the electronic fuze must be smaller than the wavelength to cause fuzing.

5. A system according to claim 4, wherein the distance is up to substantially 1.5 metres.

6. A system according to claim 1, wherein said signal is a data signal, comprising one or more of fuze setting data, time of flight data, target information data, navigation assistance data, environmental parameter data, and product/munition data.

7. A system according to claim 1, wherein said first and second antennae are induction-loop antennae.

8. An electronic fuze setter for use in an electronic fuse system, the electronic fuze setter comprising an antenna, a power supply for supplying power to said antenna, a transmitter for applying modulated data signals to said antenna, the antenna being configured to transmit said data signals by means of Near Field Communication to a compatible electronic device.

9. An electronic fuze setter according to claim 8, comprising a Near Field Communication module for receiving and processing data signals received by said antenna from a compatible electronic device by means of Near Field Communication.

10. An electronic fuze setter according to claim 8, wherein said fuze setter is mounted in or on a portable holder.

11. An electronic fuze for use in an electronic fuse system, the electronic fuze comprising an antenna and a Near Field Communication processing module for receiving and processing data signals received by said antenna from a compatible electronic device by means of Near Field Communication.

12. An electronic fuze according to claim 11, further comprising a power supply for supplying power to said antenna, and a transmitter for applying modulated signals to said antenna, the antenna being configured to transmit said data signals to a compatible electronic device by means of Near Field Communication.

13. A munition system including an electronic fuze according to claim 12.

14. A method of operating an electronic fuze having a first antenna, the method comprising bringing an electronic fuze setter having a second antenna and said electronic fuze into proximity to one another so as to induce an electromagnetic field between said first and second antennae, and thereby causing transmission of a control signal from said second antenna to said first antenna by means of a wireless communication standard.

15. A method according to claim 14, wherein said wireless communication standard is Near Field Communication.

16. A method according to claim 14, wherein said first and second antennae are induction-loop antennae.

17. A method according to claim 14, wherein the fuze setter must be within 1.5 metres of the electronic fuze device for proximity-based fuzing to occur.

18. An electronic fuze setter according to claim 8, wherein the fuze setter must be within 1.5 metres of the compatible electronic device for proximity-based fuzing to occur.

19. A munition system including an electronic fuze setter according to claim 8.

20. An electronic fuze according to claim 11, wherein the electronic fuze must be within 1.5 metres of the compatible electronic device for proximity-based fuzing to occur.
